(19) United States
(12) Patent Application Publication
(10) Pub. No.: US 2010/0323933 A1
(43) Pub. Date: Dec. 23, 2010

(54) Hydrocarbon-Based Filtercake Dissolution Fluid

(76) Inventors: Michael J. Fuller, Houston, TX (US); Laura Schafer, Highlands Ranch, CO (US); Bipin Jain, Kuala Lumpur (MY)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/490,046

(22) Filed: Jun. 23, 2009

(51) Int. Cl. C09K 8/68

(52) U.S. Cl. 507/261; 507/203; 507/266

(57) ABSTRACT

Embodiments of this invention relate to a composition and a method for dissolving a filtercake in a subterranean formation comprising forming a mixture comprising a dissolution fluid and a fluid comprising hydrocarbon; introducing the mixture into a subterranean formation containing a filtercake; introducing an aqueous fluid to the mixture; and dissolving the filtercake. Embodiments of this invention also relate to further exposing the mixture to swellable packer. Embodiments of this invention relate to a method for a composition, comprising a fluid comprising hydrocarbon; and a dissolution fluid, wherein the fluid comprising hydrocarbon and dissolution fluid are combined to form a miscible mixture that dissolves a filtercake in a subterranean formation.

### BACKGROUND

1. Field

This invention relates to fluids for use in the oil field services industry. In particular, the invention relates to methods and compositions for dissolving filter cakes.

2. Description of the Related Art

One particular means of subterranean stimulation includes exposure of a formation coated in a filter-cake to a dissolution fluid; the injected fluid is often shut-in for hours or days to slowly dissolve the filter-cake, whose coating on the formation face limits production from that formation. The filter-cake, formed often from filtration of a drilling fluid into the formation through the exposed porosity, comprises a mixture of polymer (used in the drilling fluid as a viscosifying agent and fluid-loss additive but which precipitates as a solid through leakoff into the formation), solid weighting agents (most often comprising calcium carbonate or barium sulfate), and other fine particulates which join the drilling fluid during drilling from breakdown of the formation.

The formations may comprise either carbonate or sandstone. In sandstone, these formation-particulates can include quartz, clays, shale derivatives, or any of their byproducts upon formation-exposure to aqueous or oil-based drilling mud. The filter-cake (also known as mud-cake) dissolution fluids currently used for these purposes primarily comprise acidic fluids and/or chelating agents (at varying initial pH but most commonly in acidic fluids), whose intention is to render the inorganic portion of the filtercake soluble. These acids and chelating agents most often include aqueous solutions of one or more of the following: hydrochloric acid, hydrofluoric acid, acetic acid, formic acid, methanesulfonic acid (MSA), ethylenediaminetetracetic acid (EDTA), hydroxyethylethylenediaminetriacetic acid (HEDTA), diethylenetriaminepentaacetic acid (DTPA), any of their salts or partial salts (including sodium potassium, ammonium, and other salts) as well as a number of other mineral acids, inorganic acids, organic acids, and salts and partial salts. Other components of the fluid may include “breaker” chemicals, to breakdown the polymeric portion of the filtercake that may coat the inorganic particulates; common breakers including oxidizers (such as ammonium persulfate or sodium bromate), enzymes, and mixtures of these breakers or fully encapsulated versions of these breakers.

One challenge with the execution of a filtercake removal treatment is that it is often very difficult to control the reaction rates of filtercake dissolution when subjected to downhole conditions. Premature, localized breaking of the filtercake, known as pinholing, can cause losses of the remaining filter-cake dissolution fluid into the formation and as a result insufficient removal of the filtercake along the entire interval. Therefore, being able to predict or control the rate or time of dissolution of a filtercake is highly sought-after in stimulation.

A second feature desired in filter-cake dissolution fluid is the ability to carry out other functions while downhole, as the fluid pumped downhole is rarely squeezed into the formation and followed by subsequent fluids (for the added functions). Therefore, downhole applications with the filter-cake dissolution fluid are often limited by the small volume of fluid that can be used for either filter-cake dissolution or subsequent functions. An example of an added function relates to swellable packers. Swellable packers are often in place downhole unswollen prior to filtercake dissolution. It is desired in some cases to have a fluid that can swell the packers (possibly after a shut-in period) and subsequently to carry out controlled dissolution of the filtercake under downhole conditions. These swellable packers can be optionally swellable in either aqueous or hydrocarbon media, though hydrocarbon media (such as diesel) is most common.

Thus, the oil field services industry has a need for a means of controlled dissolution of downhole filtercakes. This controlled dissolution that is obtained by controlled release of reactive chemicals in addition to a means of placing a less-reactive form of an acid downhole (for extended periods of time) which is only activated upon acid-fractionation into an aqueous post-flush fluid. Additionally, more effective compositions for an initial fluid (for packer-swelling) and a filtercake-dissolution fluid are needed.

### SUMMARY

This invention relates to a composition and a method for dissolving a filtercake in a subterranean formation comprising forming a mixture comprising a dissolution fluid and a fluid comprising hydrocarbon; introducing the mixture into a subterranean formation containing a filtercake; introducing an aqueous fluid to the mixture; and dissolving the filtercake. This invention also relates to further exposing the mixture to swellable packer. This invention relates to a method for a composition, comprising a fluid comprising hydrocarbon; and a dissolution fluid, wherein the fluid comprising hydrocarbon and dissolution fluid are combined to form a miscible mixture that dissolves a filtercake in a subterranean formation.

### BRIEF DESCRIPTION OF THE DRAWING

FIG. 1 is a sectional view of a tool that incorporates elements of embodiments of the invention.

### DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors have disclosed and enabled the entire range and all points within the range.

An embodiment of the invention involves a means of controlling activation of filter-cake dissolving fluid that has been placed into a wellbore. Specifically, the initial fluid pumped downhole involves a miscible solution of diesel and dissolution fluid (often acid) and optional mutual solvent. This fluid initially has very low reactivity toward the acid-soluble component of the filter cake (i.e. calcium carbonate) due to the low reaction rates of solutions of hydrocarbon-borne acid toward the solids. Minerals such as calcium carbonate can be exposed to a miscible acid dispersion under downhole temperature and pressure for extended periods of time (multiple days, depending on the bottomhole temperature) with minimal reaction.

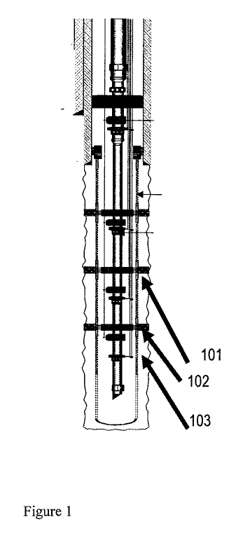

FIG. 1 is a sectional view of a tool in a wellbore in a subterranean formation that incorporates some elements of embodiments of the invention. Fluid 101 may be a composition such as MudSOLVE™. Oil-swellable material 102 may be present along the surface of a tool such as a packer. Filter cake 103 may be formed from water based mud components.

A dispersion, with high concentration of hydrocarbon, can optionally be used to swell oil-swellable packers already in place downhole over this extended period of time without filtercake dissolution. Swellable elastomers useful in the swellable elastomeric compositions may be selected from natural rubber and any substance emulating natural rubber in that they stretch under tension, have a high tensile strength, retract rapidly, and substantially recover their original dimensions. The term includes natural and man-made elastomers, and the elastomer may be a thermoplastic elastomer or a non-thermoplastic elastomer. The term includes blends (physical mixtures) of elastomers, as well as copolymers, terpolymers, and multi-polymers. Examples include ethylene-propylene-diene polymer (EPDM), various nitrile rubbers which are copolymers of butadiene and acrylonitrile such as Buna-N (also known as standard nitrile and NBR). By varying the acrylonitrile content, elastomers with improved oil/fuel swell or with improved low-temperature performance can be achieved. Specialty versions of carboxylated high-acrylonitrile butadiene copolymers (XNBR) provide improved abrasion resistance, and hydrogenated versions of these copolymers (HNBR) provide improve chemical and ozone resistance elastomers. Carboxylated HNBR is also known. In certain exemplary embodiments the swellable elastomer may be the reaction product of a linear or branched polymer having residual ethylenic unsaturation with an ethylenically unsaturated organic monomer having at least one reactive moiety selected from acid, acid anhydride, and acid salt. The swelling time may also be controlled by the identity and concentration of the solvent component of the fluid or other additives, such as surfactant.

Subsequent injection of an aqueous solution which is often denser than the hydrocarbon such as brine, acid, or other fluids (including fluids for acid-fracturing), will pass through the diesel-borne acid, will capture a large proportion of the acid from the diesel solution, and will carry the acid downhole to the filtercake to dissolve the soluble portions of the filtercake more rapidly. This aqueous fluid can be injected using standard equipment from the surface, and will reduce in pH as it travels downhole through the diesel in place (because of the lower diesel hydrocarbon density). Another means of placing the aqueous acid directly along the pay-zone coated with filtercake is using coiled-tubing and injecting or jetting the aqueous solution through the diesel-acid solution in place downhole along the filtercake. An alternate means of exposure to aqueous phase (and subsequent triggering of the acid separation from hydrocarbon) may involve production of either the water-based drilling fluid filtrate or formation water through the filtercake after the prescribed shut-in period.

Controlled chemical release or chemical reactions downhole are highly sought after in stimulation of downhole reservoirs. Embodiments of the invention use a controlled dissolution of filter-cake using a solution of acid that has been initially placed into a wellbore in an “inactive” state that is subsequently “activated” by exposure to a second fluid. Specifically, the initial fluid pumped downhole involves a miscible solution of hydrocarbon and acid and optional mutual solvent. One key to the success of this fluid is the initial high miscibility of all combined components.

Examples of the hydrocarbon include diesel, kerosene, mineral spirits, naphtha, aliphatic hydrocarbons such as hexane, cyclohexane, heptanes octane, and unsaturated hydrocarbons (such as toluene), or other hydrocarbon solvents that can render a density of the final fluid that is lower than a subsequent aqueous fluid.

Examples of the acid include organic acids such as acetic acid, formic acid, lactic acid, glycolic acid, sulfamic acid, malic acid, tartaric acid, maleic acid, methanesulfonic acid, aminopolycarboxylic acids, 3-hydroxypropionic acid, polyaminopolycarboxilic acid, and other organic acids or mixtures of organic acids and their salts or partial salts that are fully miscible in the combined solution. Other examples of the form of acid may include organic or inorganic acids such as hydrochloric acid that are stabilized in acid-internal emlusions.

Finally, mutual solvents that can be used in these fluids include ethyleneglycol monobutyl ether (EGMBE), dipropyleneglycol monomethyl ether (DPME), methanol, ethanol, isopropanol, ethylene glycol, propylene glycol, and oligomers of ethylene glycol and propylene glycol, and others.

In some embodiments, the fluid may include a surfactant. The surfactant may include an amphilphile, wettability modifier, viscoelastic surfactant, or a combination thereof.

Initial qualification of a 100 mL solution of 80% diesel+10% glacial acetic acid+10% EGMBE found that at 83 deg C., this solution alone led to a very low-dissolution of a 5 gram sample of sized-calcium carbonate over a period of days. The table below shows that this solution has very low reactivity toward the calcium carbonate under exposure to heat for a period of 6 days. However, upon addition of 50 mL of 2% aqueous KCl (to a separate ˜2 day sample), the aqueous fluid settled to the bottom of the beaker and dissolved the calcium carbonate sample in under 1 hour.

| Fluid = 100 mL 80% diesel + | | 2 | 6 | added 50 mL 2% |
|---|---|---|---|---|
| 10% EGMBE + 10% acetic acid | 1 day | days | days | KCl at 2.17 days |
| Final mass calcium carbonate | 5 | 5 | 5 | 0.709 |
| (grams) | | | | |
| %-dissolved | 0 | 0 | 0 | 85.8 |

Therefore, similar diesel-solvent-acid fluids could be prepared by changing the relative concentrations of diesel and acid or diesel, acid, and solvent. Additionally, the diesel-based mixture could contain other additives such as surfactants, demulsifiers, corrosion inhibitors, breakers, encapsulated breakers, viscosifiers, and a number of other additives. Conversely, the aqueous activator solution (final fluid) could also carry one or a number of these additives, specifically enzymes or breaker chemicals toward breaking down the polymeric portion of the filter cake as well. Therefore, the initial solution in place downhole initially has very low reactivity toward the filter cake due to the low reaction rates of hydrocarbon-borne acid toward the acid-soluble component of the cake. Other acid-soluble minerals that may be present in the filter cake may include calcium sulfate and could be dissolved on demand similarly. Conversely, other aqueous fluids have a =pH-reduction tailored to occur on demand once downhole could be injected subsequent to placement of the hydrocarbon-borne acid. These fluids could include acid-fracturing fluids, fluids intended for scale dissolution, matrix-acidizing fluids, and similar aqueous fluids.

From a practical standpoint, this initial low-reactivity of the initial diesel-solvent-acid solution could be in place for extended periods of time, assuming there is a low concentration of water in the filter cake. Injection of sufficient quantity of the diesel-based fluid (or an optional diesel preflush) could ensure that the filtercake is sufficiently water-free to minimize premature filtercake breakthrough. However, only upon exposure of the final aqueous postflush would the acid be passed into the aqueous fluid (through preferential fractionation from the hydrocarbon fluid into the aqueous fluid) and be effective to rapidly break down the filter cake.

Again, the high concentration of hydrocarbon in this two or three-component mixture can optionally be used to swell oil-swellable packers in place downhole over this extended period of time without filtercake dissolution. Diesel is a sufficient fluid to swell the elastomers of these packers. However, other hydrocarbon solvents may be equally effective. Further, the properties of the hydrocarbon phase (and choice of solvent) may impact the speed of packer-swelling. In the case of the diesel-acid or diesel-solvent-acid fluid being placed in the presence of swellable packers, subsequent injection of an aqueous solution such as brine, acid, or other fluids, will pass through the diesel-borne acid, will capture a large proportion of the acid from the diesel solution, and will carry the acid downhole to the filtercake to dissolve the soluble portions of the filtercake more rapidly. This aqueous fluid can be injected using standard equipment from the surface, to carry the acid downhole through the higher density of aqueous fluid compared to diesel. It is understood that this subsequent aqueous stage should not reverse the packer-swelling process. Additionally, in the case of a higher-density hydrocarbon-acid fluid being used, heavy brines could be used to pass through the acid-diesel fluid and through enhanced density travel downhole to the lowest portion of the borehole to attack the filter cake. Another means of placing the aqueous acid directly along the pay-zone coated with filtercake is by using coiled-tubing and injecting or jetting the aqueous solution through the diesel-acid solution in place downhole along the filtercake. This technique could be used specifically in the case of desiring to target dissolution of several targeted zones that are discontinuous along a long pay-zone.

An added feature of the fluid is the low corrosivity of the acid contained in hydrocarbon. Water based filtercake dissolution fluids with equivalent acid to the proposed solution would require corrosion inhibitor to protect the tubulars and casing from corrosion during the shut-in periods. The proposed fluid has been shown in previous tests to have extremely low corrosion rates (e.g. CIDB experiment 128:<0.049 kg/m² (0.01 lb/ft²) at 204.4 deg C. (400 deg F.) for 6 hrs on N80 steel with no corrosion inhibitor).

### EXAMPLES

The following examples are presented to illustrate the preparation and properties of fluid systems, and should not be construed to limit the scope of the invention, unless otherwise expressly indicated in the appended claims. All percentages, concentrations, ratios, parts, etc. are by weight unless otherwise noted or apparent from the context of their use.

### Example 1

### Dissolution Studies on CaCO₃ Powder

| | % Solubility & | |
|---|---|---|
| Fluid/Solid | Dispersing | Remark |
| Diesel-Acid-Solvent | 0% (after soaking for | No brine added |
| with CaCO₃ powder | 1 day) | |
| Diesel-Acid-Solvent | 0% (after soaking for | No brine added |
| with CaCO₃ powder | 2 days) | |
| Diesel-Acid-Solvent | 0% (after soaking for | No brine added |
| with CaCO₃ powder | 6 days) | |
| Diesel-Acid-Solvent | 85.8% (after soaking | After 50 mL of 2 wt % |
| with CaCO₃ powder | for 3 days then add 50 mL | KCl brine added |
| | of 2 wt % KCl | |
| | brine into Diesel- | |
| | Acid-Solvent then | |
| | filter after 1 hour) | |

The procedure to obtain these results follows.
1. The CaCO₃ solid sample is dried in the oven at 85 deg C. to remove water.
2. After drying, a 5 gram of sample is weighed as W1 and place in a 250 mL glass bottle with 100 mL of Candidate Fluid.
3. Then the glass bottles are placed in the pre-heated water bath at 83 deg C.
4. Soak the precipitant solids with treatment solution for several days.
5. The weight of crucible, paper pulp and filter paper is measured as W2.
6. Filtered the residue through paper pulp with a Gooch crucible then pass through 0.5 mm of PTFE filter paper.
7. The filtered solids, pulp, crucible and paper are dried in an oven at 85 deg C.
8. Sample is stored in a dessicator then the final total weight is measured as W3.

The solubility of filtered solid residue is calculated as:

Percent Solubility: [(W1+W2−W3)×100]/W1

### Example 2

### Dissolution Studies on CaCO3-Based Mud

| | % Solubility & | |
|---|---|---|
| Fluid/Solid | Dispersing | Remark |
| Diesel-Acid-Solvent with mud- | 0% (after soaking for 1 | No brine added |
| cake | day) | |
| Diesel-Acid-Solvent with mud- | 0% (after soaking for 2 | No brine added |
| cake | days) | |
| Diesel-Acid-Solvent with mud- | 0% (after soaking for 3 | No brine added |
| cake | days) | |
| Diesel-Acid-Solvent with mud- | 68.5% (after soaking | 50 mL of |
| cake | for 3 days then add | 2 wt % brine |
| | 50 mL of 2 wt % KCl | added |
| | brine into Diesel-Acid- | |
| | Solvent then filter after | |
| | soaking another 1 day) | |
| Diesel-Acid-Solvent with mud- | 86.8% (after soaking | 50 mL of |
| cake | for 3 days then add | 2 wt % brine |
| | 50 mL of 2 wt % KCl | added |
| | brine into Diesel-Acid- | |
| | Solvent then filter after | |
| | soaking another 2 | |
| | days) | |

1.30 sg

| Products | g/L | lb/bbl |
|---|---|---|
| Water | 784.96 | 274.73 |
| NaCl | 281.93 | 98.67 |
| Xanthan gum | 3.14 | 1.10 |
| Starch | 17.14 | 6.00 |
| Glycol | 30.00 | 10.50 |
| De-mulsifier | 2.86 | 1.00 |
| pH buffer | 5.71 | 2.00 |
| Graded calcium | 116.00 | 40.60 |
| carbonate | | |
| Graded calcium | 59.00 | 20.65 |
| carbonate | | |
| Milbio Sea 98 | 0.71 | 0.25 |

The procedure to obtain these results follows.
1. Weigh empty wash glass as (W1).
2. Using HTHP fluid loss cell and heating jacket, create a mud-cake on 6.35 cm (2.5-inch) diameter OFITE 2.7 μm filter paper by applying 3.44 MPa (500 psi) at 83 deg C. until the collected filtrate is around 10˜15 mL.
3. Take out mud-cake with filter paper from the cell and cut into 4 pieces.
4. Weigh the mud-cake with filter paper and wash glass (W2) and take a photo.
5. Pour 100 mL of Diesel-Acid-Solvent in the 250 mL glass bottle and put the mud-cake inside.
6. Close the bottle cap and soaking the mud-cake with Diesel-Acid-Solvent for 1, 2, 3 and 6 days at 83 deg C.
7. After 3 day; add additional 50 mL of 2 wt % KCl brine and observe; photograph the Diesel-Acid-Solvent/brine/mud-cake every 15 minutes for 1˜2 hours.
8. If it is not soluble, leave it for another 24 to 48 hours.
9. Remove remain mud-cake with filter paper and take a photo.
10. Weigh the mud-cake remained on filter paper with wash glass (W3).

Calculate solubility and dispersing with the following.

Percent Solubility: [(W2−W3)×100]/[W2−W1]

### Example 3

### Swelling Testing

| | Compression set Coupon | | | | Compression set button | | | |
|---|---|---|---|---|---|---|---|---|
| | | | | %-VOLUME | | | | %-VOLUME |
| HRS | WGT | DEN | VOL | SWELLING | WGT | DEN | VOL | SWELLING |
| 0 | 2.600 | 1.041 | 2.512 | 0.00 | 8.200 | 1.032 | 7.928 | 0.00 |
| 24 | 8.270 | 0.892 | 9.262 | 268.71 | 15.000 | 0.926 | 16.190 | 104.21 |
| 48 | 8.300 | 0.892 | 9.297 | 270.10 | 17.800 | 0.921 | 19.321 | 143.71 |
| 72 | 8.380 | 0.887 | 9.31 | 270.54 | 21.330 | 0.902 | 23.671 | 198.57 |
| 96 | 8.450 | 0.888 | 9.487 | 277.67 | 21.920 | 0.895 | 24.487 | 208.87 |

Fluid=80% Diesel+10% Acetic Acid+10% EGMBE (ethylene glycol monobutyl ether)

The coupon is a thin rectangle of rubber around 2 mm thick whereas the button is 2.54 cm in diameter and 1.27 cm thick

Test conditions: 82.2 deg C. (180 deg F.), no top-pressure, varied hours exposure

### Example 4

### Embodiments Based on Miscibility

| | | Observation at 25 |
|---|---|---|
| Item | Fluid System | deg C. |
| 1 | 80% v/v diesel + 10% | Miscible |
| | v/v EGMBE + 10% | |
| | v/v AcOH | |
| 2 | 80% v/v diesel + 10% | Immiscible |
| | v/v EGMBE + 10% | (Separation after 5 |
| | v/v Na3HEDTA | minutes) |
| 3 | 80% v/v diesel + 10% | Immiscible |
| | v/v EGMBE + 10% | (Separation |
| | v/v of 15% HCl | immediately) |
| 4 | 65% v/v diesel + 10% | Immiscible |
| | v/v EGMBE + 25% | (Separation after 5 |
| | v/v AcOH | minutes) |
| 5 | 40% v/v diesel + 10% | Immiscible |
| | v/v EGMBE + 50% | (Separation |
| | v/v AcOH | immediately) |
| 6 | 80% v/v diesel + 10% | Immiscible |
| | v/v EGMBE + 10% | (Separation after 5 |
| | v/v HFo | minutes) |

Here: AcOH=acetic acid; EGMBE=ethylene glycol monobutyl ether; HFo=formic acid; Na3HEDTA=solution of trisodium HEDTA

One key to the success of the fluid in maintaining controlled filtercake dissolution is the lack of water in the solution (until it is added intentionally to initiate dissolution). Therefore, the preferred embodiments of this fluid must be fully miscible. These observations show that only certain formulations are fully miscible (HCl, formic acid, and Na3HEDTA have varying amounts of water in their formulations)

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for dissolving a filtercake in a subterranean formation, comprising:
forming a mixture comprising a dissolution fluid and a fluid comprising hydrocarbon;
introducing the mixture into a subterranean formation containing a filtercake;
introducing an aqueous fluid to the mixture; and
dissolving the filtercake.

2. The method of claim 1, further comprising exposing the mixture to a swellable packer.

3. The method of claim 2, wherein the swellable packer swells.

4. The method of claim 2, wherein the packer swells upon exposure to the fluid comprising hydrocarbon.

5. The method of claim 4, wherein the swellable packer is set as part of a zonal isolation at a certain depth.

6. The method of claim 1, wherein the mixture further comprises a mutual solvent.

7. The method of claim 6, wherein the mutual solvent is ethyleneglycol monobutyl ether (EGMBE), dipropyleneglycol monomethyl ether (DPME), methanol, ethanol, isopropanol, ethylene glycol, propylene glycol, oligomers of ethylene glycol and propylene glycol, or a combination thereof.

8. The method of claim 1, wherein the fluid comprising hydrocarbon is diesel, kerosene, mineral spirits, naphtha, aliphatic hydrocarbons such as hexane, cyclohexane, heptanes octane, and unsaturated hydrocarbons (such as toluene), or a combination thereof.

9. The method of claim 1, wherein the fluid comprising hydrocarbon comprises a hydrocarbon solvent that can render a density of mixture and the aqueous fluid that is lower than the aqueous fluid before it is introduced to the mixture.

10. The method of claim 1, wherein the dissolution fluid comprises acid.

11. The method of claim 10, wherein the acid is acetic acid or hydrochloric acid stabilized in acid-internal emlusions.

12. The method of claim 10, wherein the acid is an organic acid or an aqueous acid.

13. The method of claim 1 where the dissolution fluid does not dissolve the filtercake until introduction of the aqueous fluid.

14. The method of claim 1, wherein introducing the aqueous fluid to the mixture occurs after the mixture is introduced to the subterranean formation containing a filtercake.

15. The method of claim 1, wherein the aqueous fluid is a brine solution.

16. The method of claim 1, wherein the aqueous fluid is a solution of mineral acid.

17. A composition, comprising:
a fluid comprising hydrocarbon; and
a dissolution fluid;
wherein the fluid comprising hydrocarbon and dissolution fluid are combined to form a miscible mixture that dissolves a filtercake in a subterranean formation.

18. The composition of claim 17, further comprising a mutual solvent.

19. The composition of claim 17, wherein the fluid comprising hydrocarbon is diesel.

20. The composition of claim 17, wherein the dissolution fluid comprises acid.

21 The composition of claim 20, wherein the acid is an organic acid or a miscible aqueous acid.

22. The composition of claim 20, wherein the acid is acetic acid or hydrochloric acid stabilized in acid-internal emulsions.

23. The composition of claim 20, wherein the acid is acetic acid, formic acid, lactic acid, glycolic acid, sulfamic acid, malic acid, tartaric acid, maleic acid, methanesulfonic acid, aminopolycarboxylic acids, 3-hydroxypropionic acid, polyaminopolycarboxilic acid, or mixtures, salt, or partial salts thereof.

24. The composition of claim 17, wherein the fluid further comprises a surfactant.

25. The composition of claim 24, wherein the surfactant is an amphilphile, wettability modifier, viscoelastic surfactant, or a combination thereof.
